(19) United States
(12) Patent Application Publication
(10) Pub. No.: US 2010/0181261 A1
(43) Pub. Date: Jul. 22, 2010

(54) Aqueous environment treatment apparatus and method

(75) Inventor: Bruce Ralph David Taylor, Simpsonville, SC (US)

Correspondence Address: J. BENNETT MULLINAX, LLC, P. O. BOX 26029, GREENVILLE, SC, 29616-1029, US

(73) Assignee: Eagle Research LLC, Simpsonville, SC (US)

(21) Appl. No.: 12/321,548

(22) Filed: Jan. 22, 2009

(51) Int. Cl. C02F 1/48

(52) U.S. Cl. 210/748.17; 210/138; 210/242.1

(57) ABSTRACT

A treatment apparatus is provided that may include a frame and a buoyancy member carried by the frame. The buoyancy member is configured for causing the frame to float at the surface of a body of water. An electronic homeopathic treatment device is carried by the frame and configured for delivering an electronic homeopathic treatment to the body of water.

### FIELD OF THE INVENTION

The present invention relates generally to a device and method for the treatment of aqueous environments such as lakes, ponds, rivers and streams. A particular exemplary embodiment of the present application is related to an aqueous environment treatment apparatus that floats on the surface of a body of water and delivers an electronic homeopathic treatment to the body of water in order to reduce or eliminate undesirable elements such as weeds, algae, insects and the like.

### BACKGROUND

Lakes, rivers, ponds and streams are common bodies of water found in Earth's ecosystem. Aside from being a necessary part of the environment, these types of water sources provide humans with life sustaining, economical and recreational utility. For example, bodies of water are commonly used by humans for fishing, golfing, swimming, and as ornamental landscaping features. Naturally occurring unwanted elements such as weeds, algae and insects can invade a water source and reduce its functionality or even render it unsuitable for its intended purpose. As such, the composition and aesthetic appearance of water sources are desired to be controlled.

One manner of controlling unwanted elements in bodies of water is the application of chemicals to control weeds, algae and insects. Although chemical applications are capable of eliminating unwanted elements, they may be harmful to other elements present in the aqueous environment. For instance, humans, fish or wildlife may be harmed through contact with treatment chemicals. Further, the chemicals may render the water source undrinkable and can significantly damage the environment if used improperly or if other unknown conditions concerning the water source exist.

Other methods of treating bodies of water include naturally occurring ion-exchange resins that can be placed into the water source in order to absorb ammonia that is generated in the water. It is also know to construct filters made of volcanic rock, carbons and silicates that can be submerged within the body of water preferably at a location of running water. The filter functions to absorb nutrients and minerals from the water that would otherwise provide a mechanism for algae growth. Other methods of controlling bodies of water include the introduction of bacteria or animal life to address the unwanted elements. Further, manual efforts may be employed. In this regard, weeds or algae may be raked from the surface or vacuumed from the bottom of the body of water. Yet other methods of treatment include the introduction of an organic colorant to the water in order to prevent sunlight from breaching the surface of the water to facilitate weed growth.

Electronic homeopathic technology is known for use in treating diseases in humans, animals and plants. Certain versions of this technology work by utilizing a substrate that has been magnetically altered in a desired manner for effectiveness in treating the particular condition. Electromagnetic energy that makes use of the magnetically altered substrate can be imparted onto the human or animal in order to treat the disease element. Although the use of electronic homeopathic technology in the maintenance of heath of humans, animals and plants is known, this technology is not employed in the treatment of aqueous environments. Accordingly, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a side view of an apparatus located in an aqueous environment in accordance with one exemplary embodiment

FIG. 2 is a perspective view of the bottom of a cover and an electronic homeopathic treatment device of the apparatus of FIG. 1.

FIG. 3 is a top view of the apparatus of FIG. 1.

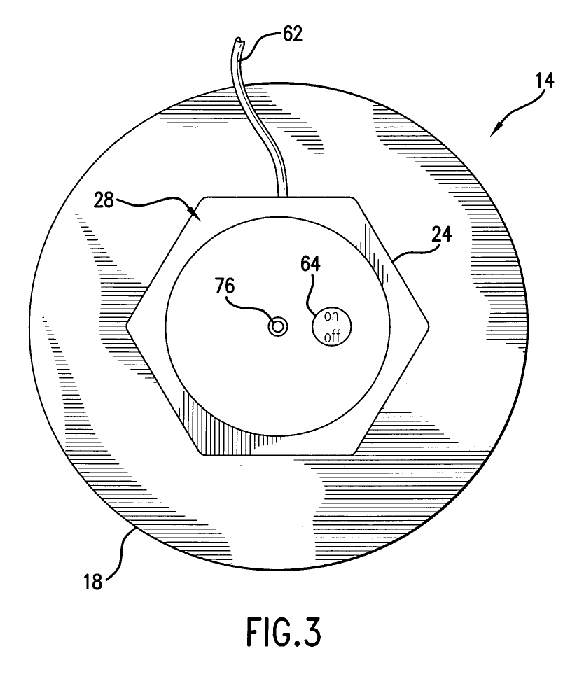

FIG. 4 is a cross-sectional side view of the apparatus of FIG. 1.

Repeat use of reference characters in the present specification and drawings is intended to represent the same or analogous features or elements of the invention.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for an apparatus 14 for use in reducing or eliminating unwanted elements 66 from an aqueous environment 10. The apparatus 14 includes an electronic homeopathic treatment device 20 that generates an electronic signal 88 from the signature frequency stored in an ampoule that is placed in a metal canister 26 suitable for use in effecting a desired result to the unwanted elements 66. The apparatus 14 may be arranged so that it is capable of floating at the surface 22 of the body of water 12 that is to be treated. The electronic homeopathic treatment device 20 may be contained inside of a waterproof frame 16 of the apparatus 14 for protection from the environment.

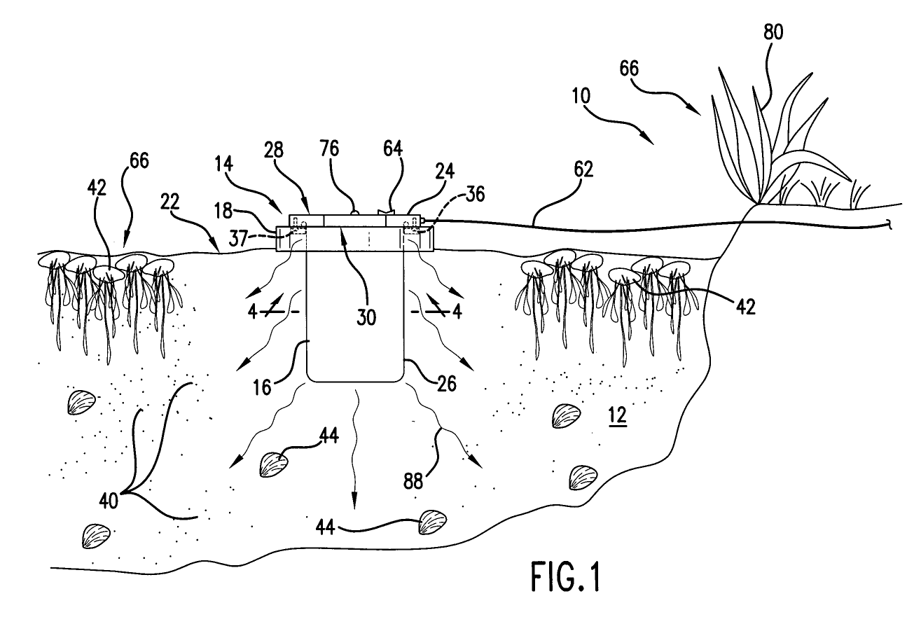

An exemplary embodiment of the apparatus 14 is illustrated in FIG. 1. The apparatus 14 is located in a body of water 12 such as a pond, lake, river, stream or the like. The apparatus 14 emits an electronic signal 88 useful in the treatment of unwanted elements 66 in the aqueous environment 10 such as algae 40, duckweed 42 and scorpion mussels 44. The electronic signal 88 may cause the reduction or elimination of the unwanted elements 66 in order to improve the functional and/or aesthetic properties of the body of water 12. It is to be understood that as used herein, the term “body of water” may be more narrow, broader, or of the same scope as the term “aqueous environment.” For example, for use in an irrigation cistern to create large volumes of a pesticide, fungicide, or herbicide homeopathic for use in irrigation sprays. In other arrangements, the apparatus 14 may be configured to only treat unwanted elements 66 present in the body of water 12 and not in other areas of the aqueous environment 10. Further embodiments are possible in which the apparatus 14 treats only certain portions of the body of water 12 and not the entire body of water 12. For example, the apparatus 14 may treat a pond but may not treat a stream running into the pond or a stream directing water out of the pond.

The apparatus 14 may be arranged so that it is capable of floating at the surface 22 of the body of water 12. The apparatus 14 includes a buoyancy member 18 designed to impart sufficient buoyancy thereto. The buoyancy member 18 may be made of a closed cell foam material in accordance with certain exemplary embodiments. The use of a strong closed cell foam material as the buoyancy member 18 may act to prevent the buoyancy member 18 from becoming waterlogged and sinking, and may also act to prevent parts of the closed cell foam material from breaking apart and polluting the body of water 12. The apparatus 14 may have a frame 16 that includes a cover 24 and a stainless steel canister 26. The stainless steel canister 26 may be disposed through an aperture in the center of the buoyancy member 18. In this regard, a force fit engagement may be made between the stainless steel canister 26 and the buoyancy member 18 so that the buoyancy member 18 is securely held onto the other portions of apparatus 14. When access is needed to various portions of the apparatus 14, the buoyancy member 18 can be slid from the stainless steel canister 26. The apparatus 14 is arranged so that the top 28 of the cover 24 rests above the surface 22 of the body of water 12 while all of, or a majority of, the stainless steel canister 26 is located below the surface 22. The buoyancy member 18 may have a generally circular cross-section and may have a diameter that is at least twice the size of the largest width of the cover 24 and/or stainless steel canister 26 in accordance with certain exemplary embodiments. The buoyancy member 18 functions to keep the apparatus 14 afloat and to prevent the apparatus 14 from shifting in the body of water 12 to keep it from becoming inverted.

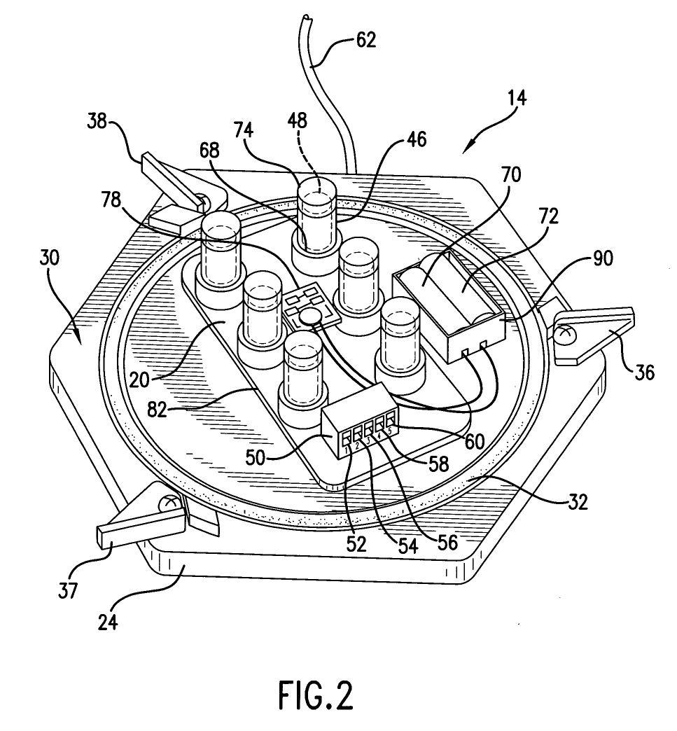

The frame 16 may be disassembled in order to access various components of the apparatus 14. FIG. 2 illustrates the bottom 30 of the cover 24 with the stainless steel canister 26 removed. The cover 24 is hexagonal in shape and serves as a base for various components of the apparatus 14. For example, various portions of the electronic homeopathic treatment device 20 are mounted to the bottom 30 of the cover 24. A circuit board 78 of the electronic homeopathic treatment device 20 is housed in a watertight member 82 and is mounted to the bottom 30 through the use of bolts or other attachment members. The watertight member 82 functions to prevent moisture from damaging the electrical components in circuit board 78. The circuit board 78 may include a microprocessor in accordance with certain exemplary embodiments. A housing 90 for use in holding batteries 70 and 72 is also mounted to the bottom 30 through the use of bolts or other suitable attachment members. The batteries 70 and 72 may be 9-volt batteries and can supply power necessary to run the electronic homeopathic treatment device 20. The footprints of the circuit board 78 and the housing 90 may be contained within a recess defined on the bottom 30. An O-ring 32 is located in the recess and likewise extends around the bottom 30 so as to form a perimeter completely about the footprints of the circuit board 78 and housing 90 attached to the bottom 30.

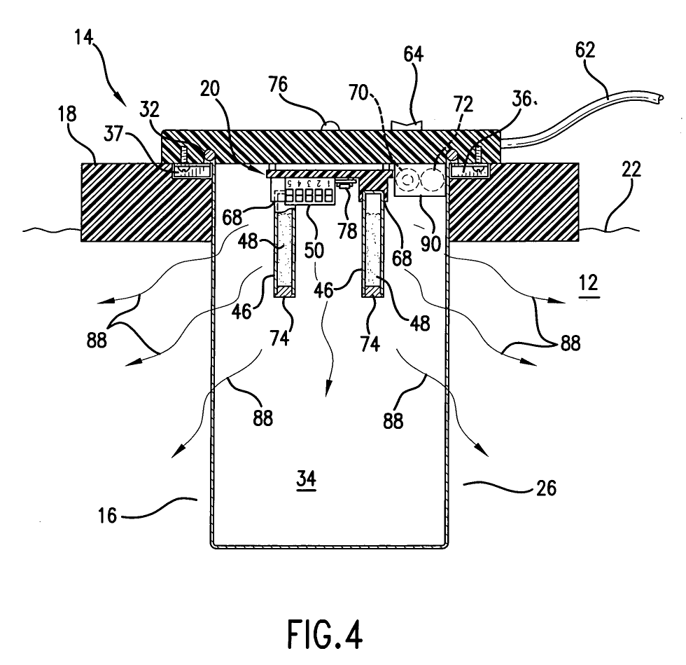

FIG. 4 is a cross-sectional view of the apparatus 14 with the stainless steel canister 26 attached to the cover 24. The O-ring 32 is provided at the point of contact between the cover 24 and the stainless steel canister 26. The cover 24 and stainless steel canister 26 are attached to one another so that they define an interior portion 34 of the frame 16. The attachment is effected so that a watertight seal is formed through the use of O-ring 32 to prevent water from the body of water 12 from entering the interior portion 34 and damaging the various electrical and electronic components included therein. The O-ring 32 may be made of rubber and may be replaced at certain time intervals as a routine maintenance procedure. Additionally or alternatively, the O-ring 32 may be replaced if water is observed within the interior portion 34. The cover 24 and the stainless steel canister 26 can be connected to one another through the use of latches 36, 37 and 38. The latches 36, 37 and 38 may be made of plastic and can be rectangular toggles. The latches 36, 37 and 38 may be pivotally connected to the bottom 30 of the cover 24 and can pivot so as to engage the stainless steel canister 26 to hold this element to the cover 24. The latches 36, 37 and 38 may move over a lip of the stainless steel canister 26 and can function to push the lip of the stainless steel canister 26 against the O-ring 32 to depress the O-ring 32 to maintain a watertight seal. The stainless steel canister 26 may not have apertures defined therein in order for the latches 36, 37 and 38 to be capable of attaching the stainless steel canister 26 and the cover 24. Although shown as being attached through the use of three latches 36, 37 and 38, it is to be understood that the attachment between the cover 24 and the stainless steel canister 26 can be effected in a variety of manners in other embodiments.

With reference now to both FIGS. 2 and 4, the electronic homeopathic treatment device 20 includes a series of receiving ports 68 that are mounted onto the circuit board 78. The receiving ports 68 are designed for receiving and holding vials 46 that contain a fluid substrate 48. The fluid substrates 48 have been magnetically altered in order to produce a desired homeopathic effect. An apparatus and method for magnetically altering a fluid substrate 48 may be found in U.S. Pat. No. 5,138,172 to Kropp, the entire contents of which are incorporated by reference herein in their entirety for all purposes. The vials 46 may be glass vials in certain embodiments and are arranged with respect to the receiving ports 68 so that the caps 74 of the vials 46 are located distal to the receiving ports 68. The vials 46 may be retained into the receiving ports 68 by way of a friction fit connection. Alternatively, a clamp or other attachment member may be present for use in effecting attachment of the vials 46 to the receiving ports 68. The vials 46 can be removed from the receiving ports 68 for replacement of the homeopathic signal in the fluid substrates 48 contained therein. Alternatively, the vials 46 may be non-removably attached to the receiving ports 68. In this regard, a user can remove the caps 74 of the vials 46 in order to gain access to the fluid substrates 48 for their removal or replacement.

The electronic homeopathic treatment device 20 functions to amplify the signals present in the fluid substrates 48 and to copy and continuously broadcast. The receiving ports 68 may be made of metal and may be capable of conducting electric signals. The six receiving ports 68 may function as antennas to conduct the signals in the fluid substrates 48 into the electronic circuit of the electronic homeopathic treatment device 20. The electronic circuit then amplifies the given signal into a coil. The coil may come into a point of contact with the stainless steel canister 26 which can emit the electronic signal 88 into the body of water. Although described as employing fluid substrates 48 that carry desired frequencies, the electronic homeopathic treatment device 20 can be variously configured in accordance with other exemplary embodiments. For example the desired frequencies may be stored in a memory of the electronic homeopathic treatment device 20 or may be contained within punch cards that are read, converted and then emitted as an electronic signal 88 by the device 20.

The electronic homeopathic treatment device 20 may be variously configured in accordance with other exemplary embodiments. For example, the electronic homeopathic treatment device 20 need not include vials 46 of fluid substrates 48. Instead, desired frequencies can be stored in a memory of the electronic homeopathic treatment device 20 or located and read on punch cards so as to result in the production of a desired electronic signal 88. In accordance with one exemplary embodiment, the electronic homeopathic treatment device 20 may be a Guardian™ electronic homeopathic treatment device that is provided by Eagle Research LLC, having offices located at 401 Balcome Boulevard, Simpsonville, S.C., USA. Also incorporated into the present application is the apparatus 14 including the electronic homeopathic treatment device marketed under the trademark Aqua Guard™ that is provided by Eagle Research LLC, having offices located at 401 Balcome Boulevard, Simpsonville, S.C., USA. Both the Guardian™ and the Aqua Guard™ devices are incorporated by reference herein in their entirety for all purposes.

The fluid substrates 48 are treated in such a manner so as to have a desired frequency. The electronic homeopathic treatment device 20 amplifies and transmits the frequency of the fluid substrates 48 and the coil through the point of contact to allow the stainless steel canister 26 to emit the electronic signal 88 into the body of water 12 which in turn will cause a desired effect upon the unwanted elements 66 such as their reduction or elimination. The electronic homeopathic treatment device 20 may increase the amplitude of the frequency of the fluid substrates 48 so that the electronic signal 88 will carry greater amplitude than that of the fluid substrates 48 alone. Any number of vials 46 of fluid substrates 48 may be employed in accordance with various exemplary embodiments. For example, a single vial 46 having a single fluid substrate 48 may be employed in accordance with one embodiment. Alternatively, up to six different vials 46 with up to six different fluid substrates 48 may be present in the apparatus 14 in other arrangements.

The fluid substrates 48 may have informational energetic signatures imparted thereon that, when in turn applied to the body of water 12, achieves a desired effect onto the particular unwanted element 66. As shown, six vials 46 having up to six different fluid substrates 48 are present in the exemplary embodiment illustrated in the figures. The vials 46 may be housed in the interior portion 34 so that they are prevented from being exposed to sunlight that may otherwise cause the established frequencies in the fluid substrates 48 to degrade or otherwise be destroyed. In this manner, the frame 16 includes opaque portions, such as the cover 24 and the stainless steel canister 26, that prevent sunlight from entering the interior portion 34. It is to be understood that as used herein, the term “vials” is the same in scope as the term “ampoules” and that the two terms may be used interchangeably with one another. The vials 46 may contain individual fluid substrates 48 that contain an algae treatment, a duck weed treatment, a scorpion mussel treatment, along with other substrates selected from undersirable water borne plant, fungal, or invertebrates animal pests. Optionally, a vial of an Enhancer substrate, as known and used in the art, may also be included. The signatures of the vials/ampoules 46 may come from various source material including but not limited to plant material, metal, animal or mineral origin. The signatures may be of pathogenic origin such as mold, fungus, virus, parasite, invertebrate such as mollusk, or bacteria. The frequencies of the six vials can be varied as desired in accordance with different exemplary embodiments. It is to be understood, however, that the types of fluid substrates 48 illustrated are but one exemplary embodiment and that others are possible. Various types of fluid substrates 48 (or homeopathic pellets) can be placed into the apparatus 14 in order to provide treatment to unwanted elements 66 as desired. The homeopathic remedies contained within the fluid substrates 48 may be selected so that humans are not harmed or adversely effected and so that animals and plants living in the aqueous environment 10 are not adversely effected. The treatment mechanism is thus non-toxic and environmentally safe. The apparatus 14 functions so that chemicals are not released into the aqueous environment 10 such that the treatment of the unwanted elements 66 is chemically free.

The electronic signal 88 is transferred through the stainless steel canister 26 and into the body of water 20. The cover 24 may be made of hard and durable plastic in accordance with certain exemplary embodiments. In certain exemplary embodiments, the electronic signal 88 is radiated out through the cover 24 in order to cause the removal or reduction of unwanted elements 66 in the body of water 12. Although described as having a plastic cover 24 and a stainless steel canister 26, it is to be understood that the frame 16 may have components that are made of the same material in accordance with other exemplary embodiments. For example, the frame 16 may be entirely constructed out of stainless steel in certain embodiments. Further, the shape of and materials consisting of the frame 16 and buoyancy member 18 may be varied in other embodiments. The stainless steel canister 26 may alternatively be a structure that is square, triangular or rectangular in cross-sectional shape and is not made out of stainless steel but of another material such as plastic. The cover 24 may be circular, square, or triangular in shape in other embodiments. Further, the buoyancy member 18 need not be circular in cross-sectional shape but may be variously configured in other embodiments.

The electronic homeopathic treatment device 20 can be configured so that it continuously emits the electronic signal 88. Alternatively, the electronic homeopathic treatment device 20 can be arranged so that it emits the electronic signals 88 at certain time intervals. Emission of the electronic signals 88 at intervals of time, as opposed to continuously over a twenty four hour interval, may provide improved performance in reducing or eliminating unwanted elements 66. In this regard, unwanted elements 66 may be more greatly effected by exposure to the electronic signals 88 at certain intervals of time than by being continuously exposed thereto. For example, some unwanted elements 66 may be significantly effected by exposure to the electronic signal 88 during the night and may have minimum reaction to exposure during the daylight hours. As such, the apparatus 14 is adjustable in that it may emit the electronic signal 88 at certain periods of time. Further, conservation of battery 70 and 72 power may be achieved if the electronic homeopathic treatment device 20 is turned off for certain lengths of time. A timer 50 may be included in the apparatus 14 and may be used to turn the electromagnetic treatment device 20 on and off for certain time periods. The timer 50 may be a switch in certain exemplary embodiments. As shown in FIG. 2, the timer 50 includes switch sw-1 52, switch sw-2 54, switch sw-3 56, switch sw-4 58, and switch sw-5 60. The switches 52, 54, 56, 58 and 60 can be set by a user in order to effect a desired on/off time period for functioning of the electronic homeopathic treatment device 20. Each one of the switches 52, 54, 56, 58 and 60 can be set into either an “up” position or to a “down” position by the user in order to have an effect on the timer 50 so that the period of emission of the electronic signals 88 are adjusted as desired. Table 1 illustrates programming functions of the switch 50 that are capable by setting the various switches 52, 54, 56, 58 and 60 as indicated. The left hand column of Table 1 represents the time in which the electronic signals 88 are either on or off as emitted by the electronic homeopathic treatment device 20.

TABLE 1

| | Switch | Switch | Switch | Switch | Switch |
|---|---|---|---|---|---|
| Timer (50) | sw-1 | sw-2 | sw-3 | sw-4 | sw-5 |
| Elect E. on/off | (52) | (54) | (56) | (58) | (60) |
| on 24 hours | Up | Up | Up | Up | Up |
| on 1 hour/off | Down | Up | Up | Up | Up |
| 23 hours | | | | | |
| on 2 hours/ | Up | Down | Up | Up | Up |
| off 22 hours | | | | | |
| on 3 hours/ | Down | Down | Up | Up | Up |
| off 21 hours | | | | | |
| on 4 hours/ | Up | Up | Down | Up | Up |
| off 20 hours | | | | | |
| on 5 hours/ | Down | Up | Down | Up | Up |
| off 19 hours | | | | | |
| on 6 hours/ | Up | Down | Down | Up | Up |
| off 18 hours | | | | | |
| on 7 hours/ | Down | Down | Down | Up | Up |
| off 17 hours | | | | | |
| on 8 hours/ | Up | Up | Up | Down | Up |
| off 16 hours | | | | | |
| on 9 hours/ | Down | Up | Up | Down | Up |
| off 15 hours | | | | | |
| on 10 hours/ | Up | Down | Up | Down | Up |
| off 14 hours | | | | | |
| on 11 hours/ | Down | Down | Up | Down | Up |
| off 13 hours | | | | | |
| on 12 hours/ | Up | Up | Down | Down | Up |
| off 12 hours | | | | | |
| on 13 hours/ | Down | Up | Down | Down | Up |
| off 11 hours | | | | | |
| on 14 hours/ | Up | Down | Down | Down | Up |
| off 10 hours | | | | | |
| on 15 hours/ | Down | Down | Down | Down | Up |
| off 9 hours | | | | | |
| on 16 hour/ | Up | Up | Up | Up | Down |
| off 8 hours | | | | | |
| on 17 hours/ | Down | Up | Up | Up | Down |
| off 7 hours | | | | | |
| on 18 hours/ | Up | Down | Up | Up | Down |
| off 6 hours | | | | | |
| on 19 hours/ | Down | Down | Up | Up | Down |
| off 5 hours | | | | | |
| on 20 hours/ | Up | Up | Down | Up | Down |
| off 4 hours | | | | | |
| on 21 hours/ | Down | Up | Down | Up | Down |
| off 3 hours | | | | | |
| on 22 hour/ | Up | Down | Down | Up | Down |
| off 2 hours | | | | | |
| on 23 hours/ | Down | Down | Down | Up | Down |
| off 1 hour | | | | | |
| on 24 hours/ | Up | Up | Up | Down | Down |
| off 24 hours | | | | | |
| on 1 hour/off | Down | Up | Up | Down | Down |
| 1 hours | | | | | |
| on 2 hours/ | Up | Down | Up | Down | Down |
| off 2 hours | | | | | |
| on 3 hours/ | Down | Down | Up | Down | Down |
| off 3 hours | | | | | |
| on 4 hours/ | Up | Up | Down | Down | Down |
| off 4 hours | | | | | |
| on 5 hours/ | Down | Up | Down | Down | Down |
| off 5 hours | | | | | |
| on 6 hours/ | Up | Down | Down | Down | Down |
| off 6 hours | | | | | |
| on 7 hours/ | Down | Down | Down | Down | Down |
| off 7 hours | | | | | |

As an example upon viewing Table 1, if all of the switches 52, 54, 56, 58 and 60 are moved to the “up” position, the electronic homeopathic treatment device 20 will emit the electronic signals 88 continuously for all hours of the day, every day, until the batteries 70 and 72 die.

The top 28 of the cover 24 includes an on/off switch 64 that can be pressed by a user in order to turn on and off the electronic homeopathic treatment device 20 so that the electronic signals 88 are emitted or not emitted. The on/off switch 64 may function so as to override the timer 50. In this manner, if the timer 50 is set so that the apparatus 14 is to continue to operate an additional two hours before shutting down, pressing of the on/off switch 64 will cause the electronic homeopathic treatment device 20 to shut off immediately before the two hours limit. The on/off switch 64 can be subsequently actuated so that the timer 50 will either restart its timing cycle, or in other embodiments, will resume its timing cycle from the point it left off. The on/off switch 64 is waterproof in certain exemplary embodiments in order to provide a convenient location for actuation by the user and to be capable of use in the given environment. The top 28 also includes a power on lamp 76 the power on lamp 76 may be a bulb or may be a light emitting diode (LED) in certain embodiments. The circuit board 78 may be designed so that insertion of the batteries 70 and 72 into the housing 90 causes the power on lamp 76 to blink. In this manner, the user will know that the batteries 70 and 72 were installed with the correct polarity. If the batteries 70 and 72 were improperly installed, the power on lamp 76 will not blink. The power on lamp 76 may be turned on when the electronic signals 88 are being emitted in order to alert the user that the apparatus 14 is in an on condition. The power on lamp 76 will be off when the apparatus 14 is off so that a user will know that the electronic signals 88 are not being generated. The power on lamp 76 may either blink or be continuously lit in order to advise one of the status of the apparatus 14.

The cover 24 may include a ring or other attachment member that allows for a rope 62 to be attached to the cover 24. In use, the apparatus 14 may be placed into the body of water 12 and function for a desired amount of time. Once maintenance, adjustment, or removal of the apparatus 14 is desired, the user may pull in the apparatus 14 though the use of rope 62 so that the user does not have to get wet or search for other retrieval mechanisms. The rope 62 can be attached to the shoreline of the body of water 12 or to another structure such as a dock, boat or weight anchor. Although described as being attached to the cover 24, the rope 62 can be attached to the buoyancy member 18 or to the stainless steel canister 26 in accordance with other exemplary embodiments.

Although described as having a buoyancy member 18, other exemplary embodiments of the apparatus 14 exists in which the buoyancy member 18 is either not present, or does not function to cause the apparatus 14 to float at the surface 22 of the body of water 12. For example, the apparatus 14 may be designed so that it sinks to and rests on the bottom of the body of water 12. The apparatus 14 may function in such a position to emit the electronic signals 88 for the removal of unwanted elements 66. The buoyancy member 18 may alternatively be present but may only be capable of causing the apparatus 14 to be positioned halfway between the surface 22 and the bottom, or any other spot between the surface 22 and the bottom of the body of water 12. The apparatus 14 can emit electronic signals 88 in these locations so that unwanted elements 66 are treated.

It is to be understood that as used herein, that the term treatment refers to the reduction and/or elimination of unwanted elements 66. Further, it is to be understood that the term reducing unwanted elements 66 also includes elimination of unwanted elements 66, and that the term elimination of unwanted elements 66 includes reduction of unwanted elements 66.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A treatment apparatus, comprising:
a frame;
a buoyancy member carried by the frame and configured for causing the frame to float at the surface of a body of water; and
an electronic homeopathic treatment device carried by the frame and configured for delivering an electronic homeopathic treatment to the body of water.

2. The treatment apparatus as set forth in claim 1, wherein the buoyancy member is made of closed cell foam material, and wherein when located in the body of water a portion of the frame is located above the surface of the body of water and a portion of the frame is located under the surface of the body of water.

3. The treatment apparatus as set forth in claim 1, wherein the frame has a cover and a stainless steel canister, wherein the stainless steel canister is releasably attachable to the bottom of the cover, wherein the stainless steel canister is disposed through the buoyancy member, and wherein the buoyancy member contacts the bottom of the cover.

4. The treatment apparatus as set forth in claim 3, wherein the electronic homeopathic treatment device transmits electronic signals that broadcast from the stainless steel canister and into the body of water.

5. The treatment apparatus as set forth in claim 3, further comprising an O-ring that seals the connection between the stainless steel canister and the cover when the stainless steel canister and the cover are attached so as to form a waterproof interior portion of the frame, wherein at least a portion of the electronic homeopathic treatment device is located in the waterproof interior portion of the frame, and further comprising three latches that effect releasable attachment between the stainless steel canister and the cover.

6. The treatment apparatus as set forth in claim 1, wherein the electronic homeopathic treatment device is configured for emitting established frequencies capable of reducing algae, duckweed, and scorpion mussels from the body of water.

7. The treatment apparatus as set forth in claim 1, wherein the electronic homeopathic treatment device has a plurality of vials that each contain a fluid substrate with information energy imparted thereto, wherein the electronic homeopathic treatment device emits an electronic signal that includes the frequency signatures contained within the fluid substrates to the body of water.

8. The treatment apparatus as set forth in claim 1, further comprising a timer configured for turning on and off the electronic homeopathic treatment device so that the electronic homeopathic treatment is applied at intervals of time.

9. The treatment apparatus as set forth in claim 1, further comprising a rope attached to the frame, and wherein the electronic homeopathic treatment device has a waterproof on/off switch that is located on the frame for selection by a user.

10. An apparatus for treating a body of water, comprising:
a frame that defines a waterproof interior portion; and
an electronic homeopathic treatment device carried by the frame and configured for delivering an electronic homeopathic treatment to the body of water, wherein at least a portion of the electronic homeopathic treatment device is located in the waterproof interior portion of the frame.

11. The apparatus as set forth in claim 10, further comprising a buoyancy member carried by the frame and configured for causing the frame to float at the surface of the body of water.

12. The apparatus as set forth in claim 11, wherein the frame has a cover and a stainless steel canister, wherein the stainless steel canister is releasably attachable to the bottom of the cover, wherein the stainless steel canister is disposed through the buoyancy member and has at least a portion that is located under the surface of the body of water, wherein the electronic homeopathic treatment device transmits electronic signals through the stainless steel canister and into the body of water.

13. The apparatus as set forth in claim 10, wherein the electronic homeopathic treatment device is configured for emitting electronic frequencies capable of reducing algae, duckweed, and scorpion mussels from the body of water.

14. The apparatus as set forth in claim 10, wherein the electronic homeopathic treatment device has a plurality of vials that each contains a fluid substrate with information energy imparted thereto, wherein the electronic homeopathic treatment device emits electronic signals that include frequencies contained within the fluid substrates to the body of water, wherein the plurality of vials are releasably attachable to receiving ports of the electronic homeopathic treatment device, wherein the electronic homeopathic treatment device has a battery for use in providing power thereto, wherein the electronic homeopathic treatment device has a timer configured for turning on and off the electronic homeopathic treatment device so that the electronic homeopathic treatment is applied at intervals of time.

15. The apparatus as set forth in claim 10, further comprising a rope attached to the frame, and wherein the electronic homeopathic treatment device has a waterproof on/off switch that is located on the frame for selection by a user.

16. A method for treating a body of water for the removal of at least one unwanted element, comprising the steps of:
providing an electronic homeopathic treatment device configured for the treatment of the at least one unwanted element;
turning on the electronic homeopathic treatment device so that electronic signals are delivered therefrom;
positioning the electronic homeopathic treatment device in a body of water so that the electronic signals are delivered to the body of water for treatment of the at least one unwanted element.

17. The method as set forth in claim 16, wherein the positioning step includes positioning the electronic homeopathic treatment device so that the electronic homeopathic treatment device floats at the surface of the body of water.

18. The method as set forth in claim 16, wherein the electronic homeopathic treatment device is configured for the reduction of algae, duckweed, and scorpion mussels from the body of water.

19. The method as set forth in claim 16, further comprising the step of timing the electronic homeopathic treatment device so that the electronic signals delivered therefrom are applied at intervals of time.

20. The method as set forth in claim 16, wherein the electronic homeopathic treatment device has a plurality of vials that each contains a fluid substrate with information energy imparted thereto, wherein the plurality of vials are removable from the electronic homeopathic treatment device and replaceable with different vials having a fluid substrate with information energy imparted thereto in order to effect a different treatment to the body of water.
